(19) United States
(12) Patent Application Publication
(10) Pub. No.: US 2011/0087522 A1
(43) Pub. Date: Apr. 14, 2011

(54) METHOD FOR DEPLOYING A PROBING ENVIRONMENT FOR PROVISIONED SERVICES TO RECOMMEND OPTIMAL BALANCE IN SERVICE LEVEL AGREEMENT USER EXPERIENCE AND ENVIRONMENTAL METRICS

(75) Inventors: Kirk A. Beaty, Hawthorne, NY (US); Rick A. Hamilton, II, Charlottesville, VA (US); Neal M. Keller, Yorktown Heights, NY (US); Andrzej Kochut, Hawthorne, NY (US); Clifford A. Pickover, Yorktown Heights, NY (US); Elizabeth J. Poole, Yorktown Heights, NY (US); Mariusz Sabath, Yorktown Heights, NY (US); Emmanuel Yashchin, Yorktown Heights, NY (US); Alexander Zlatsin, Yorktown Heights, NY (US)

(73) Assignee: INTERNATIONAL BUSINESS MACHINES CORPORATION, Armonk, NY (US)

(21) Appl. No.: 12/575,987

(22) Filed: Oct. 8, 2009

(51) Int. Cl. G06Q 10/00; G06Q 50/00

(52) U.S. Cl. 705/7.38; 705/308; 705/7.11

(57) ABSTRACT

A system and method of determining performance metrics for inclusion in a Service Level Agreement (SLA) between a customer and a host computing service provider. The method comprises: receiving a provisioning request from a customer including receiving computing performance requirement parameters and environmental parameters for inclusion in the SLA from the customer; deploying discovery tools to identify relevant infrastructure components based on performance metrics. Based on identification of the customer's relevant infrastructure components, probes are deployed and installed. Then, data is obtained from the probes while changing infrastructure components for simulating and assessing impact of one or more different customer scenarios for different performance policies. In one aspect, the obtained data is used to identify and implement an a priori risk sharing agreement between the customer and service provider. In a further aspect, the data obtained for simulating and assessing impact of one or more different customer policies include data for simulating and assessing different environmental policies.

### BACKGROUND

1. Technical Field

The present invention relates generally to a distributed computer system, and more particularly to providing a service level agreement that balances performance objectives and generation of minimum environment pollutant metrics.

2. Description of Related Art

As the exponential growth in interact usage continues, much of which is fueled by the growth and requirements of different aspects of electronic business, there is an increasing need to provide Quality of Service (QoS) performance guarantees across a wide range of high-volume commercial web site environments. A fundamental characteristic of these commercial environments is the diverse set of services provided to support customer requirements. Each of these services have different levels of importance to both the service providers and their clients. To this end, Service Level Agreements (SLAs) have been established between service providers and their clients so that different QoS requirements can be satisfied. Once an SLA is in effect, the service providers must make appropriate resource management decisions.

One such environment in which SLAs are of increasing importance is in web server farms. Web server farms are becoming a major means by which web sites are hosted. The basic architecture of a web server farm is a cluster of web servers that allow various web sites to share the resources of the farm, i.e. processor resources, disk storage, communication bandwidth, and the like. In this way, a web server farm supplier may host web sites for a plurality of different clients.

In managing the resources of the web server faun, traditional resource management mechanisms attempt to optimize conventional performance metrics such as mean response time and throughput. However, merely optimizing performance metrics does not take into consideration tradeoffs that may be made in view of meeting or not meeting environmental concerns. In other words, merely optimizing performance metrics does not provide an indication of the amount of environmental pollutants generated due to meeting or not meeting the service level agreements.

Thus, it would be beneficial to have an apparatus, method and system for managing system resources under service level agreements based on environmental pollutants such as carbon footprint metrics rather than or in addition to strictly using conventional performance metrics to minimize the amount of pollutants generated under an SLA.

### SUMMARY

The present invention provides a system, method, and computer program product for providing optimal initial Service Level Agreement (SLA) metrics that balance customer desired computing performance objectives with environment polluting parameters. The system, method, and computer program product consist of formulating SLA metrics provided by probes that monitor performance, infrastructure resource utilization and environmental affecting pollutants as a network flow model.

In a first aspect, there is disclosed a method of determining performance metrics for inclusion in a Service Level Agreement (SLA) between a customer and a host computing service provider. The method comprises: receiving a provisioning request from a customer; receiving computing performance requirement parameters for inclusion in an SLA from the customer; deploying discovery tools for providing performance metrics for identifying relevant infrastructure components; receiving the performance metrics for identifying the customer's relevant infrastructure components; deploying and installing probes based on identification of that customer's relevant infrastructure components; obtaining data from the probes while changing infrastructure parameters for simulating and assessing impact of one or more different customer policies for different performance policies; and using the obtained data to identify and implement an a priori risk sharing agreement.

In still another embodiment there is disclosed a system of determining performance metrics for inclusion in a Service Level Agreement (SLA) between a customer and a host computing service provider. The system comprises: means for receiving a provisioning request from a customer; means for receiving computing performance requirement parameters for inclusion in an SLA from the customer; means for deploying discovery tools for providing performance metrics for identifying relevant infrastructure components; means for receiving the performance metrics for identifying the customer's relevant infrastructure components; one or more probes adapted to be deployed and installed based on identification of that customer's relevant infrastructure components; means for obtaining data from the probes while changing infrastructure parameters for simulating and assessing impact of one or more different customer policies for different performance policies; and means for using the obtained data to identify and implement an a priori risk sharing agreement.

In still another embodiment there is disclosed a computer program product for use with a computer, the computer program product including a computer readable medium having recorded thereon a computer program or program code for causing the computer to perform a method for storing and retrieving data. The method comprises: receiving a provisioning request from a customer; receiving computing performance requirement parameters for inclusion in an SLA from the customer; deploying discovery tools configured for providing performance metrics to identify relevant infrastructure components; receiving the performance metrics and identifying the customer's relevant infrastructure components from the metrics; deploying and installing probes based on identification of that customers relevant infrastructure components; obtaining data from the probes while changing infrastructure parameters for simulating and assessing impact of one or more different customer policies for different performance policies; and using the obtained data to identify and implement an a priori risk sharing agreement.

The foregoing has outlined, rather broadly, the preferred feature of the present invention so that those skilled in the art may better understand the detailed description of the invention that follows. Additional features of the invention will be described hereinafter that faun the subject of the claims of the invention. Those skilled in the art should appreciate that they can readily use the conception and specific embodiment as a base for designing or modifying the method for carrying out the same purposes of the present invention and that such other features do not depart from the spirit and scope of the invention is its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is an exemplary block diagram illustrating a network data processing system according to one embodiment of the present invention;

FIG. 2 is an exemplary block diagram illustrating a server device according to one embodiment of the present invention;

FIG. 3 is an exemplary block diagram illustrating a client device according to one embodiment of the present invention;

FIG. 4 is an exemplary diagram of a Web server farm in accordance with the present invention; and

FIG. 5 is a flow chart of a function of an embodiment of the invention.

### DETAILED DESCRIPTION OF THE PREFERRED EMBODIMENT

In this description, a service agreement is part of a service contract in which the level of service is formally defined. A Service Level Agreement (SLA) is a formally negotiated agreement between two of more parties.

The term green refers to the practice of using resources which minimize the generation of undesired pollutants that are added to the environment. Such resources may include the use of recycled materials, power used during the transport and packaging of items, overall power use, power used by computers which are in turn used to operate a product distribution system, recyclability of products, presence of heavy metals in products, and a carbon footprint which related to some of the stated parameters.

A carbon footprint may be defined as a measure of the impact human activities have on the environment in terms of the amount of greenhouse gases produced, measured in units of carbon dioxide. It is meant to be useful for individuals and organizations to conceptualize their individual or organizational impact in contributing to global warming.

The service level that is to be provided to a given customer is defined by certain terms that are set forth in a service level agreement and the service measurement data is stored on a time basis in a database. The obtained data for the SLA can be processed by a software tool located in a computer.

The present invention provides a mechanism by which environmental pollutants such as greenhouse gases generated in accordance with terms of SLAs are minimized. The present invention may be implemented in any distributed computing system, a stand-alone computing system, or any system in which an environment pollutant is generated based on a service level agreement.

Service Level Agreements (SLA) for provisioned services are often determined by negotiations between business owners and service providers or customers either directly or through their Information Technology (IT) departments. The provisioned services may refer to requirements and/or preferences that are specifically recited in the SLA. That is, by way of example, such provisioned services may deal with how environmental issues, such as the generation and/or release of a regulated substance, are handled while insuring a certain level of business owner satisfaction and complying with the SLA. As is known, businesses increasingly enter into a service level agreement with a service provider or a customer.

An SLA provides a means by which the expectations of the service provider or client and the business owner can be negotiated. The SLA defines terms and conditions for a service. It may, for example, include green parameters, metrics and/or constraints for maximum environmental emissions that should be generated, use of recycled materials, overall power use, power used by equipment such motors, lights, etc., which in turn are used to operate a product distribution system, the presence of heavy metals in a product, a carbon footprint, and the like. Metrics can be obtained by the discovery tools or probes and cost of metrics easily calculated. As known, probes may include software located on a service provider site and run within its infrastructure. However, having ability to provide the probes on a customer environment increases flexibility. Probes could further be a hardware appliance that can be installed in either Service Provider, customer or third party (well predefined world-wide locations that execute transactions on demand) location. In one embodiment, functions of the probe is to discover relationships between relevant infrastructure components, measure transaction parameters to establish baselines used to identify potential service tradeoffs to customers, and, to verify performance of the operational service according to agreed upon SLA.

Often there is a disconnect between the parties because SLA metrics that are defined are normally neither based on objective data nor modified automatically as changes in resource consumption, environmental costs and the like occur which will enable the sharing of risks between the business and the service provider or customer. As a result, a customer may object to increased charges by a business owner, or a service provider may be required to provide additional resources at its own expense thus making the contract less profitable.

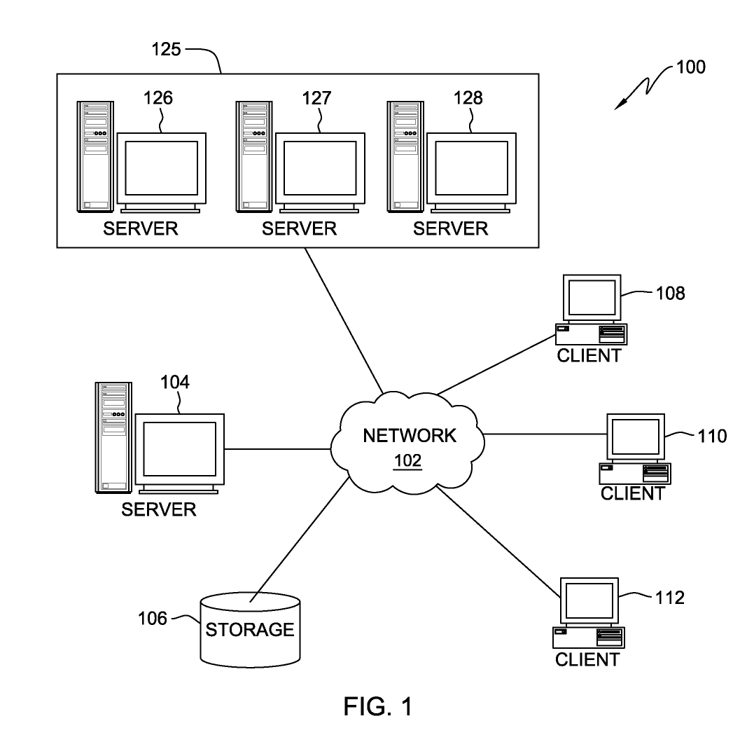

Because the present invention may be implemented in many different computing environments, a discussion of a distributed network, server computing device, client computing device, and the like, will now be provided with regard to FIGS. 1-3 in order to provide a context for the exemplary embodiments to follow. Although an implementation in web server farms will be described, those skilled in the art will recognize and appreciate that the present invention is significantly more general purpose and is not limited to use with web server farms.

Referring to FIG. 1, there is shown a pictorial representation of a computing infrastructure, e.g., network of data processing system 100 which uses a substantial amount of electricity and, therefore, with which the present invention may be implemented. Network data processing system 100 contains a network, 102 (which may comprise a LAN,WAN, an internet or the Internet), which is the medium used to provide communications links between various devices and computers connected together within network data processing system 100.

A server 104 is connected to network 102 along with storage unit 106. In addition, client devices 108, 110, and 112 also are connected to network 102. Clients 108, 110, and 112 may be, for example, laptop, notebook, desktop or mobile computers or network computers. In the example, server 104 provides data, such as boot files, operating system images, and applications to clients 108-112. Clients 108, 110, and 112 are clients to server 104. Network data processing system 100 may include additional servers, clients, and other devices not shown.

In an embodiment, network data processing system 100 is the Internet with network 102 representing a worldwide collection of networks and gateways that communicate with one another. At the heart of the Internet is a backbone of high-speed data communication lines between major nodes or host computers, consisting of thousands of commercial, government, educational and other computer systems that route data and messages.

Additionally shown in FIG. 1, connected to network 102 is a server farm or cluster 125 comprising server devices 126-128. Server farm may include a plurality of web servers providing services for a client.

Web site clients enter into service level agreements with web server farm 125 provider regarding various classes of service to be provided by the Web server farm 125. For example, a service level agreement may indicate that a browsing client device is to be provided a first level of service, a client device having an electronic shopping cart with an item therein is provided a second level of service, and a client device that is engaged in a “check out” transaction is given a third level of service. Based on this service level agreement, resources of the web server farm are allocated to the Web sites of the Web site clients to handle transactions with client devices. Normally, environmental issues are not included as a metric in the SLA. In the present invention, a program is implemented for managing the allocation of these web server farm resources in combination with selecting a supplier of electrical energy based on the type of fuel used by the electrical supplier to generate electricity for operating the server farm under the service level agreement in order to minimize the generation of environmental pollutants under the service level agreements.

In one aspect, the present invention provides a mechanism by which resources are managed so as to minimize the generation of undesired environment pollutants while providing customer desired performance objectives while satisfying service level agreements.

The present invention is described with regard to a Web server farm, however, the invention is not limited to such. As mentioned above, the present invention may be implemented in a server, client device, stand-alone computing system, Web server farm, or the like.

Referring to FIG. 4, a web server farm 400 is represented by a distributed data processing system consisting of M heterogeneous servers 420-432 that independently execute K classes of request streams, where each request is destined for one of N different web client web sites. As shown in FIG. 4, the web server farm 400 can include a request dispatcher 410 coupled to plurality of servers 420-432. The request dispatcher 410 that receives requests via network 102 destined for a Web site supported by the Web server farm 400. The request dispatcher 410 determines an appropriate server to handle the request and reroutes the request to the identified server. The request dispatcher 410 also serves as an interface for outgoing traffic from the Web server farm 400 to the network 102.

Every Web site supported by the Web server farm 400 has one or more classes of requests which may or may not have service level agreement (SLA) requirements. The requests of each class for each web site, may be served by a subset of the servers 420-432 comprising the Web server farm 400.

In a further aspect, the present invention provides a mechanism for selecting a supplier of electrical energy for use by each request and each server eligible to serve such request. More precisely, the present invention selects a source of electrical power based on the type of fuel used to generate the electricity and the amount and type of pollutants that are created by generating the electricity for use by the server farm for the Web sites. Thus, the present invention determines which requests are actually served by servers that are powered with electricity generated by low environmental polluting fuels in order to minimize adverse effects to the environment under an SLA.

The present invention thus addresses environmental concerns which may be addressed each time a customer request is served in a manner that satisfies the corresponding service level agreement. Likewise, a penalty may be paid each time a request is not served in a manner that satisfies the corresponding service level agreement. An exception to this premise may be a provision of a “best efforts” requirement in the service level agreement which has a flat rate pricing policy with zero penalty, for example. In the present invention, there is implemented a system directed to providing metrics obtained with probes for an SLA which balance performance objectives and green parameters to minimize the generation of environmental pollutants by selecting an electrical supplier that uses the least amount of polluting fuel.

Information received from probes is supplied to a monitoring and measurement tool to monitor performance, infrastructure resource utilization and environmental parameters under different simulated user policies. The measurement tool can resides on a diagnostic/measurement server that captures, aggregates, and correlates service performance metrics to enable an internet service provider (ISP) to assess the performance of the service being provided to customers.

The measurement data from probes that is captured, aggregated and correlated by the monitoring and measuring tool located at a server of an internet service provider can be included in SLA reports that describe the actual quality of services that customers are receiving. Those skilled in the art will understand the manner in which a monitoring and measurement tool can be utilized in conjunction with probes to capture, aggregate and correlate service performance metrics.

To monitor actual performance, strategically deployed service probes are used to obtain data of resource utilization and environmental parameters under actual operating conditions. The data obtained from the probes is fed to the monitoring tool to automatically obtain true operating metrics for comparison with the metrics in a service level agreement. Additionally, the data obtained from the probes can be used to support risk sharing relative to environmental parameters in the service level agreement via a priori options.

Typical probes which can be deployed to collect data, verify performance, measure resource utilization, measure energy consumption under different simulated user conditions, and measure undesired pollutants being generated are as follows:
network probes, to see if all units are on-line;
web access probes to check if a web server is responding, and verifies the requested number of concurrent connections that can be processed;
web services environmental probes to deploy a sample application on application server;
authentication probes to check whether a server is properly responding;
sample SQL probes to verify if the sample database can be accessed and if the permissions are correctly set;
sample read/write probes to verify if appropriate files can be accessed; and,
delta energy consumption probes for different user policies.

Information that can be included in the SLA includes the maximum or a minimum amount of megawatts during a designated interval of time such as a week, the source of energy that is used to generate the electricity, the type of energy such as oil, gas, coal and the estimated BTU cost of the source of energy. Another condition in the SLA can be the impact that the burning of the fuel has on the environment such as its carbon foot print (measured, for example, in terms of Kilograms of CO₂ per kilowatt hour of electricity generated from the burning of the fuel).

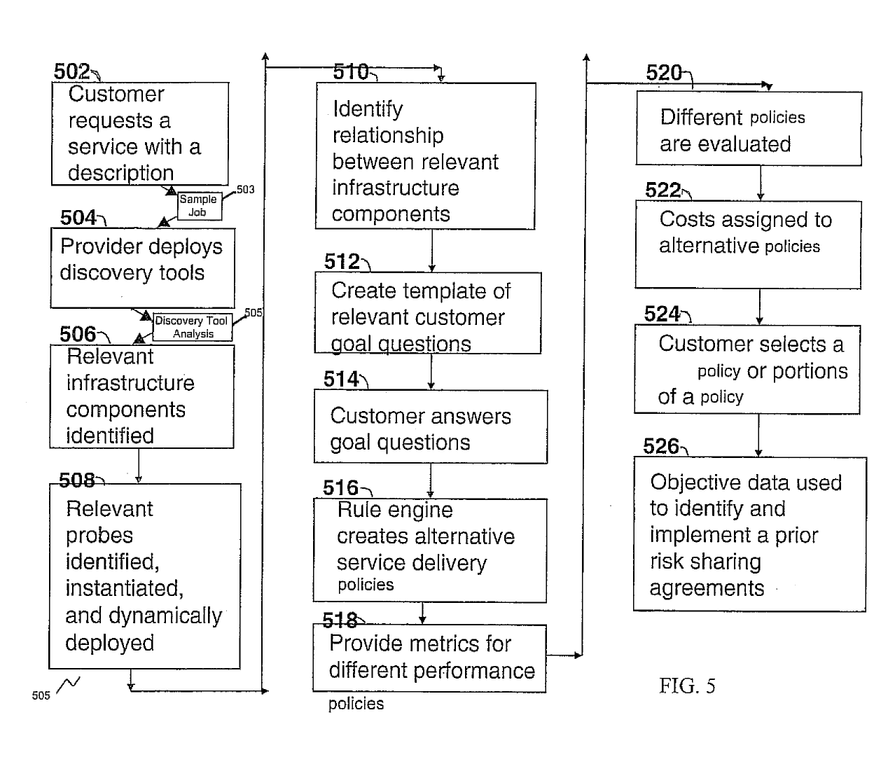

In one embodiment of the invention, a customer is interested in entering into an SLA with a provider such as a server farm. Referring to FIG. 5, flow chart 500, the process is started when the customer contacts a server farm and submits a provisioning request, which includes a specification of an amount of greenhouse gases (e.g., in units of carbon dioxide) that will be produced by the electrical utility selected by the server farm for each megawatt of power the farm will use while providing services under the SLA and a request that includes performance requirements, e.g., CPU time, data rate, response time, utilization, maximum concurrent transactions, bandwidth etc. at block 502, to a service provider. Optionally, the customer may also provide a sample job, block 503. Upon receiving the request and performance from the customer, the provider deploys discovery tools that can reside on a diagnostic/measurement server that aggregates and correlates service performance metrics to identify relevant infrastructure components, block 504. Discovery tools, such as those that scan the network and look for packets that include information about protocols, well-known ports, and frequency of communication, for example, may be implemented for listening to the network traffic and analyzing the relationships between all the clients and servers at block 505. By analyzing the communication patterns, such tools are able to identify the role the specific system is playing in the environment. For example, they could identify that a back-end database is used by the web application with the front end web service. They could also identify what communication is used for the external clients and what internal communication takes place between system components. These tools also analyze and test the common ports and verify whether common protocols are active on the available systems. As a result, the discovery tools can identify if a server communicates with other specific servers, using what protocols, and how often. For example, if communication is frequent and large amounts of data are transported between servers, the probability of having a significant dependency between these two servers is very high. This dependency would indicate that bandwidth between these servers would be a primary performance requirement in any SLA. In one example embodiment, an open source tool such as “Nmap” (“Network Mapper”) (http://nmap.org/data/COPYING) can be used which is a utility for network exploration or security auditing and is useful for tasks such as network inventory, managing service upgrade schedules, and monitoring host or service uptime. Nmap uses raw IP packets in novel ways to determine what hosts are available on the network, what services (application name and version) those hosts are offering, what operating systems (and OS versions) they are running, what type of packet filters/firewalls are in use, and dozens of other characteristics.

Further in FIG. 5, based on the analysis, the relevant infrastructure components are then identified, block 506 and, at block 508 the relevant probes are identified, instantiated and dynamically deployed. At this time, the relationship between relevant infrastructure components is identified, block 510. Referring to blocks 504 through 510, the discovery tools and probes thus define the relationship between the resources. Based on the relationships, the potential relevant service policies can be identified. Once the relationships among infrastructure are defined and known, the appropriate set of probes is deployed. Probes execute transactions that emulate the user interaction with the service, e.g., measure how long it takes to download a web site, or open the database and execute query. These performance measurements are required to build a complete picture of the discovered environment. As a result of these measurements, the baselines can be created and system can start auto-developing new policies. For example, under typical conditions, the response time to the web site is 30 ms and it takes 200 concurrent transactions (200 clients) to increase the response to 50 ms, because of the bandwidth requirements or the limitations on how many queries can be processed concurrently to the back-end database, for example. In another example, the probes go to a database and see a linkage between the database and a web application. The web server communicates with a web application that depends on an LDAP server for authentication and a database to provide data.

Once the relationships are known and the performance data (e.g., the response time, availability, response codes, throughput, CPU and memory utilization, etc.) is collected, the system builds a questionnaire for a customer. A template, in one embodiment, may be used to automatically generate a questionnaire of relevant customer goal questions, block 512 and the customer provides answers to goal questions, at block 514. In one example, in the build of a service delivery policy, the customer may be asked what there preferences are or what is important to them. Then, the discovery tools and probes are run to create a template with questions for the customer to answer in terms of their goals/preferences for service delivery. In one example, a customer can request, as a provision in an SLA, a fast database access/response, but that raises the costs. The customer should decide if the speed of the database or the number of customers who can be served concurrently is of prime importance. In a further example, a transaction that takes one minute and is secure can be acceptable for a bank but not for real time stock trading where a trader would want both security and a fast transaction which would cost extra.

As a further example, once it is discovered and known what services are used and how they communicate between each other, a sample questionnaire for a three-tier architecture (Presentation tier, application/business tier, data tier) may be generated as follows:
What is the most important element of your service?
number of concurrent transactions/customers processed (throughput)
speed of the transaction
quality interface
secure connection
GUI look and feel
How many transactions you want to support?
10/s
200/s
5,000/s
1,000,000/s
Do you need a failover or backup service?
Do you want to be supported by a cluster design?
Do you have greenhouse gases emission limits?
Would you prefer to use the power coming from renewable resources?

In a further embodiment, the system implements an expert system, including a rule engine creates alternative service delivery policies, block 516. For example, the system may ask the rule engine a question, and the rule engine generates advice that is given in terms of recommended policies, with weighting for different factors—performance, environmental cost, security, etc. For example, the inventive system could identify a service delivery policy which includes tradeoffs between performance and green characteristics, based on expressed customer tradeoffs (preferences).

Continuing, the method then provides metrics for different performance policies, block 518. The policies are built by combining the customer's stated goals (preferences) with the results from the discovery tools and probes. For example, combining separate servers on the host can be tested to see the result in terms of performance requirements.

The different policies are evaluated in terms of cost, block 520, and compared with costs assigned to alternative policies, block 522. Cost is determined by the amount of resources required to deliver each policy. For example, if it is a shared resource, the cost is determined by the percent of resource allocated to that customer's service delivery. The determination of cost associated with the delivery of resources is known by those with knowledge in the art.

The method advances to block 524 where the customer selects a policy or portions of a policy. Thereafter, the method uses objective data to identify and implement an a priori risk sharing agreement, block 526. For example, possible fluctuations in the availability of wind power based on future weather reports provide some uncertainty which the provider and customer can agree to share via a priori options.

Based on objective data, the provider is confident that the provisioned service according to the revised SLA metrics can be provided with a flexibility to leverage “clean energy resources.”

In a further embodiment, a customer in block 524 may choose from policies which involve various combinations of metrics related to environmental parameters. For example, one set of metrics could specify energy generated using oil and a cost of M; a second set of metrics could specify energy generated using natural gas and a cost of N; and a third set of metrics could specify energy generated using a 50% mix of coal and wind power and a cost of P. Suppose that in block 502 the customer had submitted a provisioning request which included performance requirements of a maximum end user response time of 200 ms and a minimum 99.9% uptime, an environmental requirement of 20% “clean” (wind, solar, etc.) energy, and a maximum price of $200,000 for one year of service. A rule engine creates alternative service delivery policies (block 516) and the method then provides metrics for different performance policies (block 518). The policies are built by combining the customer's stated goals (preferences) with the results from the discovery tools and probes. In this embodiment of the invention, the data from the discovery tools and probes indicate that if the customer modifies their SLA performance requirement to allow a maximum end user response time of 250 ms instead of 200 ms, and agrees to reduce the required minimum uptime requirement to 98%, they can either: increase their percentage of “clean” energy used to 30% for the same $200,000 annual cost, thus benefiting their “green” brand and gaining increased carbon offsets, or achieve their original environmental goal of 20% “clean” energy for a reduced annual contract price of $170,000. As known, a foot print is a financial instrument aimed at a reduction in greenhouse gas emissions. Carbon offsets are measured in metric tons of carbon dioxide-equivalent (CO₂e) and may represent six primary categories of greenhouse gases. One carbon offset represents the reduction of one metric ton of carbon dioxide or its equivalent in other greenhouse gases.

As an alternative to focusing on static policies based on customer preferences regarding tradeoffs after relationships between infrastructure components are identified by discovery tools and studied via probes to establish baselines, it is understood that the probes may also be used to identify, in real time, changes in external scenarios which could suggest a shift to a different policy. As an example, suppose an inexpensive source of green energy suddenly becomes available which could save more than 10% in energy costs taking into account switching costs with the added benefit of gaining increased carbon offsets (a new scenario) and the probes indicate that the user performance would be degraded less than 10%. In this example the service delivery policy might change dynamically to allow the switch to the new energy source. Not all scenarios can be anticipated; thus, the probe based system may further be configured to dynamically generate new service delivery policies in real time, i.e., probes can be leveraged to enable the generation of dynamic service delivery policies.

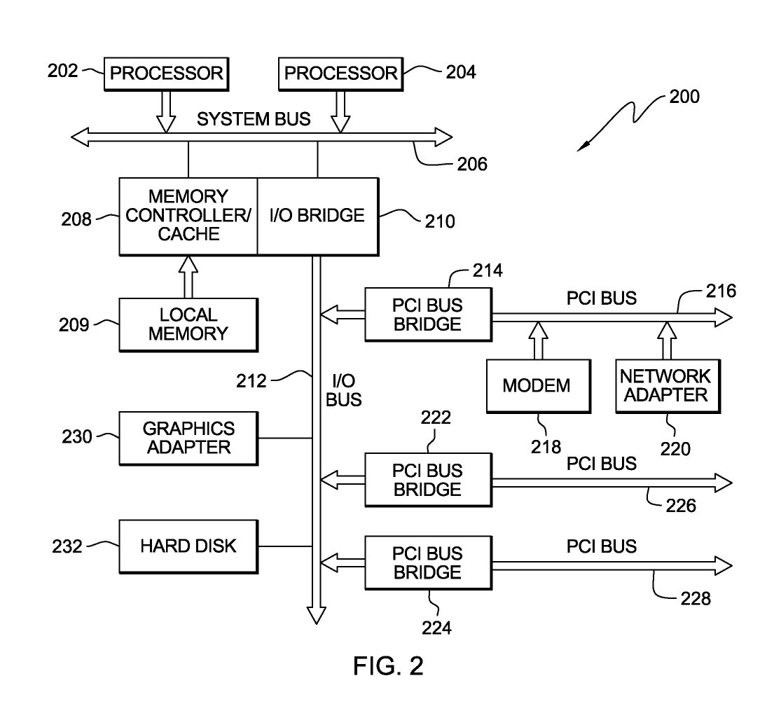

Referring to FIG. 2, there is shown a block diagram of a data processing system that may be implemented as a server, such as server 104 or a server in the Web server farm 125 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212.

Peripheral Component Interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. I may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212.

Those of ordinary skill in the art will appreciate that the hardware shown in FIG. 2 may vary. For example, other peripheral devices, such as optical disk drives and the like, also may be used in addition to or in place of the hardware shown.

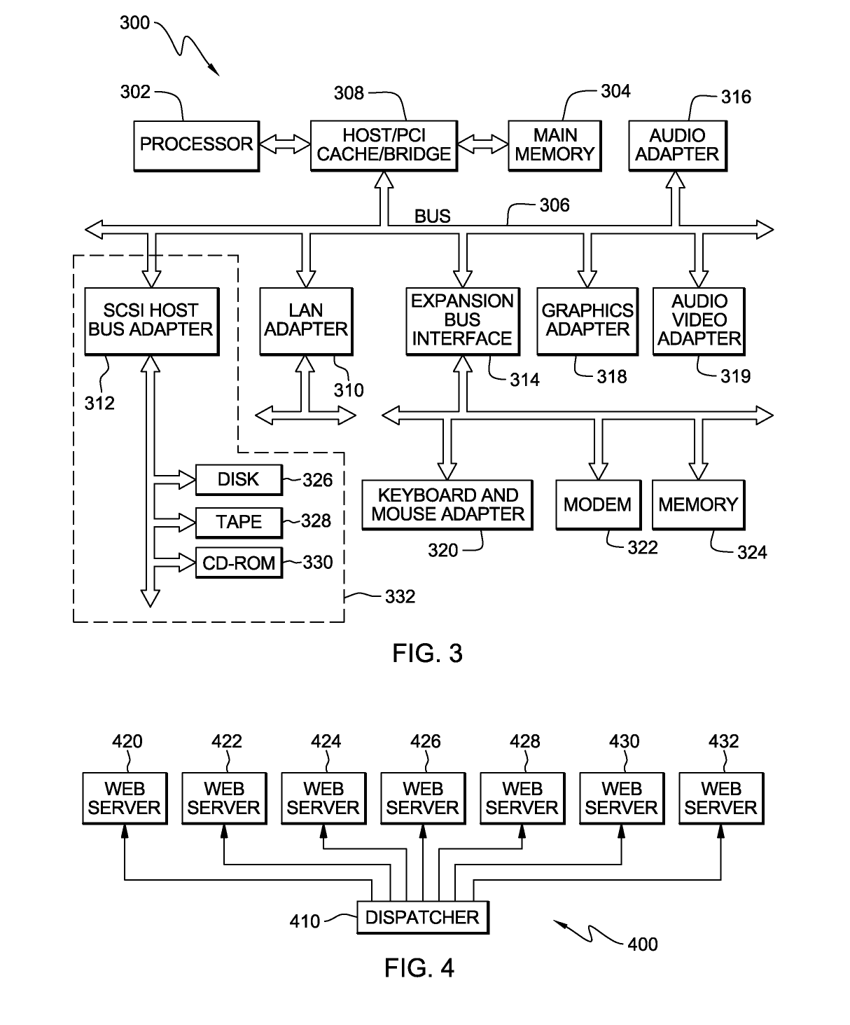

Referring to FIG. 3, there is shown a block diagram illustrating a data processing system. Data processing system 300 is an example of a client computer having a peripheral component interconnect (PCI) local bus architecture. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. Local area network (LAN) adapter 310, SCSI host bus adapter 312, and expansion bus interface 314 are connected to PCI local bus 306 by direct component connection. Audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. Instructions for the operating system, the object-oriented operating system, and applications or programs are located on storage devices, such as hard disk drive 326, and may be loaded into main memory 304 for processing by processor 302.

Those of ordinary skill in the art will appreciate that the hardware in FIG. 3 may vary depending on the implementation. Other internal hardware or peripheral devices, such as flash ROM or optical disk drives and the like, may be used in addition to or in place of the hardware depicted in FIG. 3.

The various method embodiments of the invention will be generally implemented by a computer processing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and processed, carries out the method, and variations on the method as described herein. Alternatively, a specific use computer, containing specialized hardware for carrying out one or more of the functional tasks of the invention, could be utilized.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program produce embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM) or Flash memory), an optical fiver, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then complied, interpreted, of otherwise processed in a suitable manner, if necessary, and then stored in a computer memory. In the context of this document, a computer-usable or computer-readable medium may be any medium that can contain, store, communicate, propagate, or transport the program for use by or in connection with the instruction processing system, apparatus, or device. The computer-usable medium may include a propagated data signal with the computer-usable program code embodied therewith, either in baseband or as part of a carrier wave, The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider).

The present invention is described above with reference to flow chart illustrations and/or block diagrams of methods, apparatus (systems) and computer program products according to embodiments of the invention. It will be understood that each block of the flow chart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instructions means which implement the function/act specified in the flowchart and/or block diagram block of blocks.

The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although a few examples of the present invention have been shown and described, it would be appreciated by those skilled in the art that changes might be made in these embodiments without departing from the principles and spirit of the invention, the scope of which is defined in the claims and their equivalents.

What is claimed is:

1. A method for determining performance metrics for inclusion in a Service Level Agreement (SLA) between a customer and a service provider, the method comprising:
receiving a provisioning request from a customer;
receiving computing performance requirement parameters for inclusion in said SLA from said customer;
receiving environmental parameters for inclusion in said SLA from said customer;
deploying discovery tools configured to identify the customer's relevant infrastructure components based on performance metrics;
deploying and installing probes based on identification of said customer's relevant infrastructure components;
obtaining data from said probes while changing infrastructure parameters for simulating and assessing impact of one or more different customer policies for different performance policies; and
using said obtained data to identify and implement an a priori risk sharing agreement between said customer and service provider,
wherein a processor unit runs a program to execute one or more of said receiving, deploying tools and probes and obtaining data for said simulating and assessing.

2. The method according to claim 1, wherein said data obtained for simulating and assessing impact of one or more different customer policies include data for simulating and assessing different environmental conditions.

3. The method according to claim 1, further comprising: recommending, from said data obtained from said probes, at least one set of optimal and one set of alternative initial SLA metrics and contract costs that balances the customers desired performance objectives and a green parameter.

4. The method according to claim 3 wherein said alternative initial SLA metrics and contract cost are based on modified environmental parameters.

5. The method according to claim 4 further comprising:
using said metrics as support for said customer and said provider sharing risk in the event said environmental parameters are not met.

6. The method according to claim 1 wherein said environmental parameters includes energy being consumed.

7. The method according to claim 6 wherein said environmental parameters includes a time of day that said energy is being consumed.

8. The method according to claim 7 wherein said environmental parameters includes a carbon footprint of said energy being consumed.

9. The method according to claim 8 wherein said environmental parameters includes a type of said energy being consumed.

10. A computer system for determining performance metrics for inclusion in a Service Level Agreement (SLA) between a customer and a service provider comprising:
a memory;
a processor in communications with the computer memory, wherein the computer system is capable of performing a method comprising:
receiving a provisioning request from a customer;
receiving computing performance requirement parameters for inclusion in said SLA from said customer;
receiving environmental parameters for inclusion in said SLA from said customer;
deploying discovery tools to identify the customer's relevant infrastructure components based on performance metrics;
deploying and installing probes based on identification of said customer's relevant infrastructure components;
obtaining data from said probes while changing infrastructure parameters for simulating and assessing impact of one or more different customer policies for different performance policies; and
using said obtained data to identify and implement an a priori risk sharing agreement between said customer and service provider.

11. The computer system according to claim 10, wherein said data obtained for simulating and assessing impact of one or more different customer policies include data for simulating and assessing different environmental conditions.

12. The computer system according to claim 10 wherein said data from said probes are used to recommend at least one set of optimal and one set of alternative initial SLA metrics and contract costs that balances the customers desired performance objectives and a green parameter.

13. The computer system according to claim 12 wherein said alternative initial SLA metrics and contract cost are based on modified environmental parameters.

14. The computer system according to claim 13 further comprising:
using said metrics as support for said customer and said provider sharing risk in the event said environmental parameters are not met.

15. The computer system according to claim 10 wherein said environmental parameters includes energy being consumed.

16. The computer system according to claim 15 wherein said environmental parameters includes a time of day that said energy is being consumed.

17. The computer system according to claim 16 wherein said environmental parameters includes a carbon footprint of said energy being consumed.

18. The computer system according to claim 16 wherein said environmental parameters includes a type of said energy being consumed.

19. A computer program product for performing a method for determining performance metrics for inclusion in a Service Level Agreement (SLA) between a customer and a service provider, said computer program product comprising:
a storage medium readable by a processing unit and storing instructions for processing by the processing unit for performing a method comprising:
receiving a provisioning request from a customer;
receiving computing performance requirement parameters for inclusion in said SLA from said customer;
receiving environmental parameters for inclusion in said SLA from said customer;
deploying discovery tools to identify the customer's relevant infrastructure components based on performance metrics;
deploying and installing probes based on identification of said customer's relevant infrastructure components;
obtaining data from said probes while changing infrastructure components for simulating and assessing impact of one or more different customer policies for different performance policies; and
using said obtained data to identify and implement an a priori risk sharing agreement between said customer and service provider.

20. The computer program product according to claim 19, wherein said data obtained for simulating and assessing impact of one or more different customer policies include data for simulating and assessing different environmental conditions.

21. The computer program product of claim 19 wherein said data from said probes are used to recommend at least one set of optimal and one set of alternative initial SLA metrics and contract costs that balances the customers desired performance objectives and a green parameter.

22. The computer program product of claim 21 wherein said alternative initial SLA metrics and contract cost are based on modified environmental parameters.

23. The computer program product of claim 22 further comprising:
using said metrics as support for said customer and said provider sharing risk in the event said environmental parameters are not met.

24. The computer program product of claim 20 wherein said environmental parameters includes energy being consumed.

25. The computer program product of claim 24 wherein said environmental parameters includes a time of day that said energy is being consumed.

26. The computer program product of claim 25 wherein said environmental parameters includes a carbon footprint of said energy being consumed.

27. The computer program product of claim 26 wherein said environmental stewardship parameters includes a type of said energy being consumed.

28. A method of deploying a computer program product for determining performance metrics for inclusion in a Service Level Agreement (SLA) between first and second entities, wherein, when processed, the computer program performs the steps of
receiving a provisioning request from a first entity;
receiving computing performance requirement parameters for inclusion in said SLA from said first entity;
receiving environmental parameters for inclusion in said SLA from said first entity;
deploying discovery tools to identify relevant infrastructure components based on performance metrics;
deploying and installing probes based on identification of said first entity's relevant infrastructure components;
obtaining data from said probes while changing infrastructure components for simulating and assessing impact for said first entity of one or more different policies for different performance policies; and
using said obtained data to identify and implement an a priori risk sharing agreement between said first and second entities.

29. The method of deploying a computer program product according to claim 28, wherein said data obtained for simulating and assessing impact of one or more different customer policies include data for simulating and assessing different environmental policies.
